(19) United States
(12) Patent Application Publication
(10) Pub. No.: US 2012/0113223 A1
(43) Pub. Date: May 10, 2012

(54) User Interaction in Augmented Reality

(75) Inventors: Otmar Hilliges, Cambridge (GB); David Kim, Cambrige (GB); Shahram Izadi, Cambridge (GB); David Molyneaux, Oldham (GB); Stephen Edward Hodges, Cambridge (GB); David Alexander Butler, Cambridge (GB)

(73) Assignee: Microsoft Corporation, Redmond, WA (US)

(21) Appl. No.: 12/940,383

(22) Filed: Nov. 5, 2010

(51) Int. Cl. H04N 13/02; G06T 17/00

(52) U.S. Cl. 348/46; 345/420; 348/E13.074

(57) ABSTRACT

Techniques for user-interaction in augmented reality are described. In one example, a direct user-interaction method comprises displaying a 3D augmented reality environment having a virtual object and a real first and second object controlled by a user, tracking the position of the objects in 3D using camera images, displaying the virtual object on the first object from the user's viewpoint, and enabling interaction between the second object and the virtual object when the first and second objects are touching. In another example, an augmented reality system comprises a display device that shows an augmented reality environment having a virtual object and a real user's hand, a depth camera that captures depth images of the hand, and a processor. The processor receives the images, tracks the hand pose in six degrees-of-freedom, and enables interaction between the hand and the virtual object.

### BACKGROUND

In an augmented reality system, a user's view of the real world is enhanced with virtual computer-generated graphics. These graphics are spatially registered so that they appear aligned with the real world from the perspective of the viewing user. For example, the spatial registration can make a virtual character appear to be standing on a real table.

Augmented reality systems have previously been implemented using head-mounted displays that are worn by the users. A video camera captures images of the real world in the direction of the user's gaze, and augments the images with virtual graphics before displaying the augmented images on the head-mounted display. Alternative augmented reality display techniques exploit large spatially aligned optical elements, such as transparent screens, holograms, or video-projectors to combine the virtual graphics with the real world.

For each of the above augmented reality display techniques, there is a problem of how the user interacts with the augmented reality scene that is displayed. Where interaction is enabled, it has previously been implemented using indirect interaction devices, such as a mouse or stylus that can monitor the movements of the user in six degrees of freedom to control an on-screen object. However, when using such interaction devices the user feels detached from the augmented reality environment, rather than feeling that they are part of (or within) the augmented reality environment.

Furthermore, because the graphics displayed in the augmented reality environment are virtual, the user is not able to sense when they are interacting with the virtual objects. In other words, no haptic feedback is provided to the user when interacting with a virtual object. This results in a lack of a spatial frame of reference, and makes it difficult for the user to accurately manipulate virtual objects or activate virtual controls. This effect is accentuated in a three-dimensional augmented reality system, where the user may find it difficult to accurately judge the depth of a virtual object in the augmented reality scene.

The embodiments described below are not limited to implementations which solve any or all of the disadvantages of known augmented reality systems.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Techniques for user-interaction in augmented reality are described. In one example, a direct user-interaction method comprises displaying a 3D augmented reality environment having a virtual object and a real first and second object controlled by a user, tracking the position of the objects in 3D using camera images, displaying the virtual object on the first object from the user's viewpoint, and enabling interaction between the second object and the virtual object when the first and second objects are touching. In another example, an augmented reality system comprises a display device that shows an augmented reality environment having a virtual object and a real user's hand, a depth camera that captures depth images of the hand, and a processor. The processor receives the images, tracks the hand pose in six degrees-of-freedom, and enables interaction between the hand and the virtual object.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an augmented reality system with direct user-interaction;

FIG. 2 illustrates a flowchart of a process for providing haptic feedback in a direct interaction augmented reality system;

FIG. 3 illustrates an augmented reality environment with controls rendered on a user's hand;

FIG. 4 illustrates an augmented reality environment with a virtual object manipulated on a user's hand;

FIG. 5 illustrates an augmented reality environment with a virtual object and controls on a user's fingertips;

FIG. 6 illustrates a flowchart of a process for detecting gestures to control interaction in a direct interaction augmented reality system;

FIG. 7 illustrates an augmented reality environment with a gesture for virtual object creation;

FIG. 8 illustrates an augmented reality environment with a gesture for manipulating an out-of-reach virtual object;

FIG. 9 illustrates an example augmented reality system using direct user-interaction; and

FIG. 10 illustrates an exemplary computing-based device in which embodiments of the direct interaction augmented reality system may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a desktop augmented reality system, the system described is provided as an example and not a limitation. As those skilled in the art will appreciate, the present examples are suitable for application in a variety of different types of augmented reality systems.

Described herein is an augmented reality system and method that enables a user to interact with the virtual computer-generated graphics using direct interaction. The term “direct interaction” is used herein to mean an environment in which the user's touch or gestures directly manipulates a user interface (i.e. the graphics in the augmented reality). In the context of a regular two-dimensional computing user interface, a direct interaction technique can be achieved through the use of a touch-sensitive display screen. This is distinguished from an “indirect interaction” environment where the user manipulates a device that is remote from the user interface, such as a computer mouse device.

Note that in the context of the augmented reality system, the term “direct interaction” also covers the scenario in which a user manipulates an object (such as a tool, pen, or any other object) within (i.e. not remote from) the augmented reality environment to interact with the graphics in the environment. This is analogous to using a stylus to operate a touch-screen in a 2D environment, which is still considered to be direct interaction.

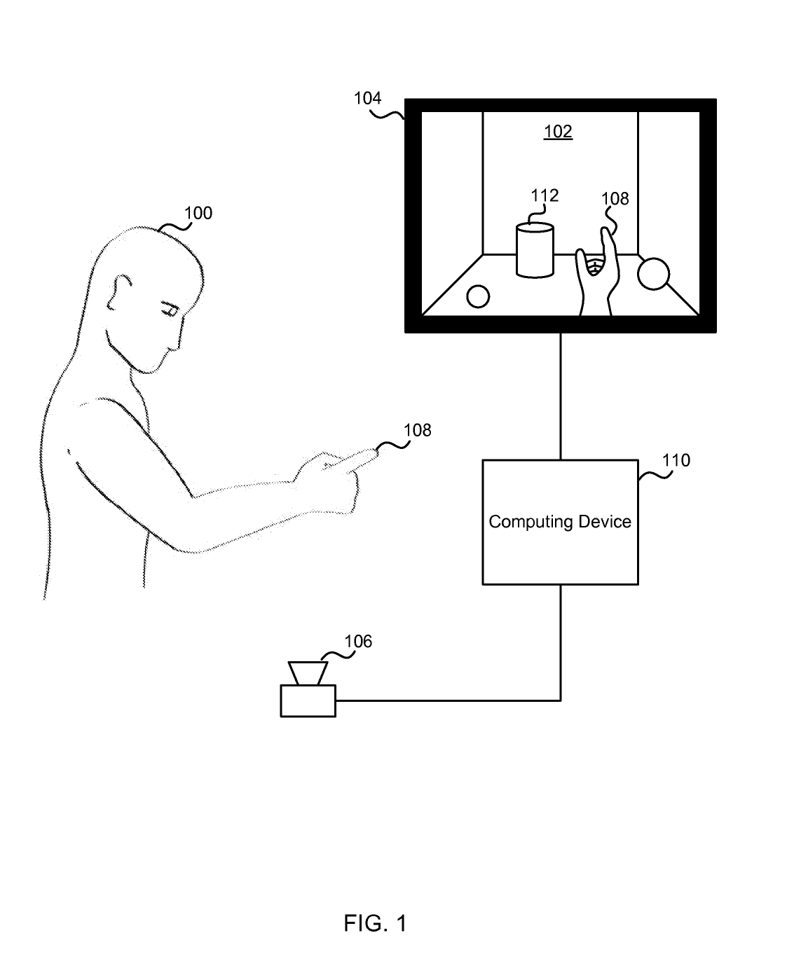

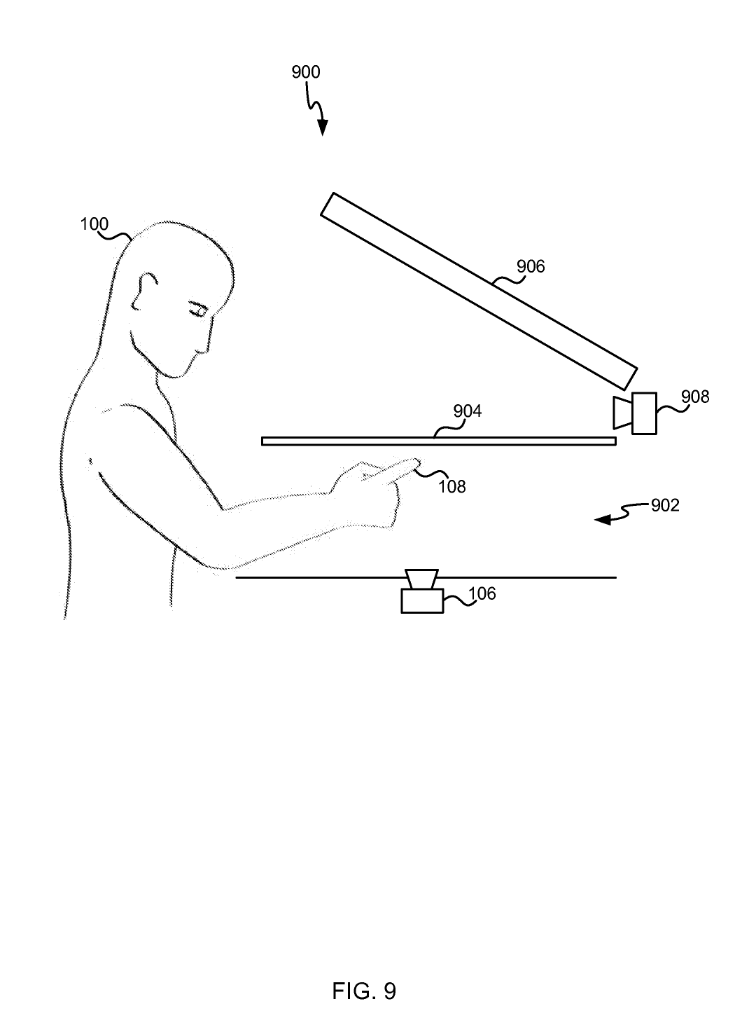

An augmented reality system is a three-dimensional system, and the direct interaction also operates in 3D. Reference is first made to FIG. 1, which illustrates an augmented reality system that enables 3D direct interaction. FIG. 1 shows a user 100 interacting with an augmented reality environment 102 which is displayed on a display device 104. The display device 104 can, for example, be a head-mounted display worn by the user 100, or be in the form of a spatially aligned optical element, such as a transparent screen (such as a transparent organic light emitting diode (OLED) panel), hologram, or video-projector arranged to combine the virtual graphics with the real world. In another example, the display device can be a regular computer display, such as a liquid crystal display (LCD) or OLED panel, or a stereoscopic, autostereoscopic, or volumetric display, which is combined with an optical beam splitter to enable the display of both real and virtual objects. An example of such a system is described below with reference to FIG. 9. The use of a volumetric, stereoscopic or autostereoscopic display enhances the realism of the 3D environment by enhancing the appearance of depth in the 3D virtual environment 102.

A camera 106 is arranged to capture images of one or more real objects controlled or manipulated by the user. The objects can be, for example, body parts of the user. For example, the camera 106 can capture images of at least one hand 108 of the user. In other examples, the camera 106 may also captures images comprising one or more forearms. The images of the hand 108 comprise the fingertips and palm of the hand. In a further example, the camera 106 can capture images of a real object held in the hand of the user.

In one example, the camera 106 is a depth camera (also known as a z-camera), which generates both intensity/color values and a depth value (i.e. distance from the camera 106) for each pixel in the images captured by the camera. The depth camera can be in the form of a time-of-flight camera, stereo camera or a regular camera combined with a structured light emitter. The use of a depth camera enables three-dimensional information about the position, pose, movement, size and orientation of the real objects to be determined. In some examples, a plurality of depth cameras can be located at different positions, in order to avoid occlusion when multiple objects are present, and enable accurate tracking to be maintained.

In other examples, a regular 2D camera can be used to track the 2D position, posture and/or movement of the user-controlled real objects, in the two dimensions visible to the camera. A plurality of regular 2D cameras can be used, e.g. at different positions, to derive 3D information on the real objects.

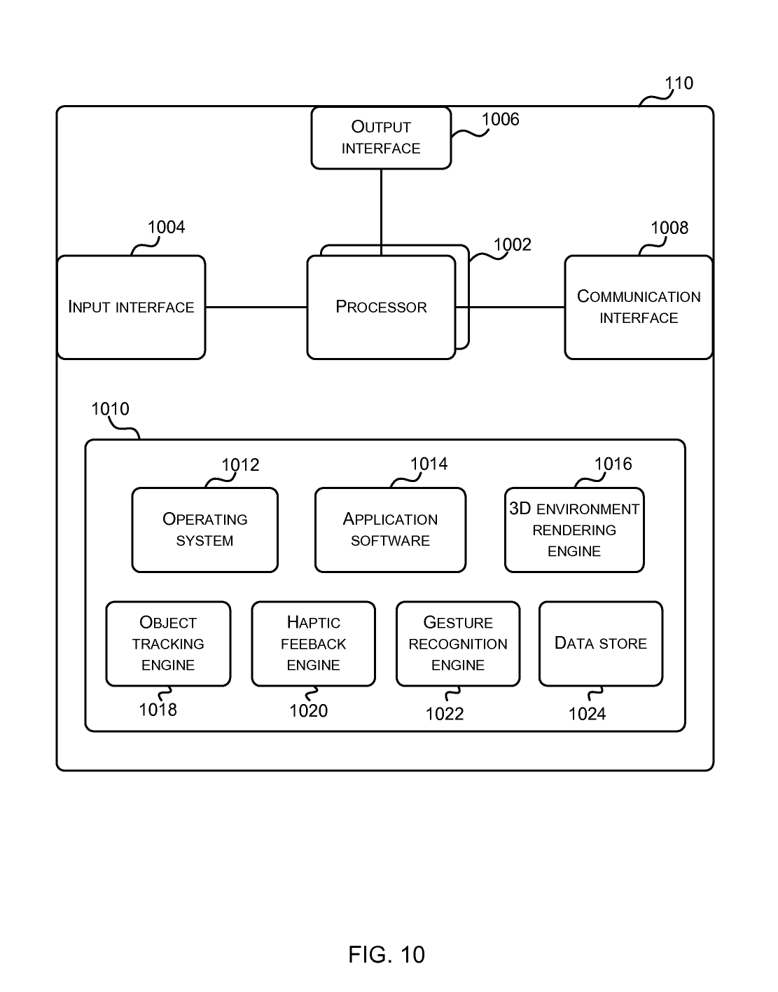

The camera provides the captured images of the user-controlled real objects to a computing device 110. The computing device 110 is arranged to use the captured images to track the real objects, and generate the augmented reality environment 102, as described in more detail below. Details on the structure of the computing device are discussed with reference to FIG. 10.

The above-described augmented reality system of FIG. 1 enables the user 100 to use their own, real body parts (such as hand 108) or use a real object to directly interact with one or more virtual objects 112 in the augmented reality environment 102. The augmented reality environment 102 when viewed from the perspective of the user 100 comprises the tracked, real objects (such as hand 108), which can be the actual body parts of the user or objects held by the user if viewed directly through an optical element (such as a beam splitter as in FIG. 9 below), an image of the real objects as captured by a camera (which can be different to camera 106, e.g. a head mounted camera), or a virtual representation of the real object generated from the camera 106 images.

The computing device 110 uses the information on the position and pose of the real objects to control interaction between the real objects and the one or more virtual objects 112. The computing device 110 uses the tracked position of the objects in the real world, and translates this to a position in the augmented reality environment. The computing device 110 then inserts an object representation that has substantially the same pose as the real object into the augmented reality environment at the translated location. The object representation is spatially aligned with the view of the real object that the user can see on the display device 104, and the object representation may or may not be visible to the user on the display device 104. The object representation can, in one example, be a computer-derived virtual representation of a body part or other object, or, in another example, is a mesh or point-cloud object directly derived from the camera 106 images. As the user moves the real object, the object representation moves in a corresponding manner in the augmented reality environment 102.

As the computing device 110 also knows the location of the virtual objects 112, it can determine whether the object representation is coincident with the virtual objects 112 in the augmented reality environment, and determine the resulting interaction. For example, the user can move his or her hand 108 underneath virtual object 112 to scoop it up in the palm of their hand, and move it from one location to another. The augmented reality system is arranged so that it appears to the user that the virtual object 112 is responding directly to the user's own hand 108. Many other types of interaction with the virtual objects (in addition to scooping and moving) are also possible. For example, the augmented reality system can implement a physics simulation-based interaction environment, which models forces (such as impulses, gravity and friction) imparted/acting on and between the real and virtual objects. This enables the user to push, pull, lift, grasp and drop the virtual objects, and generally manipulate the virtual objects as if they were real.

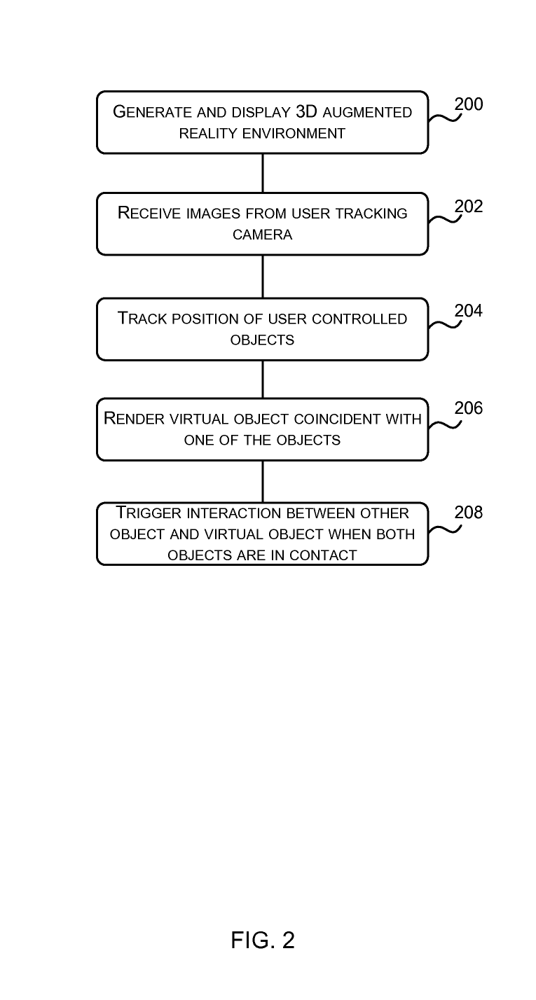

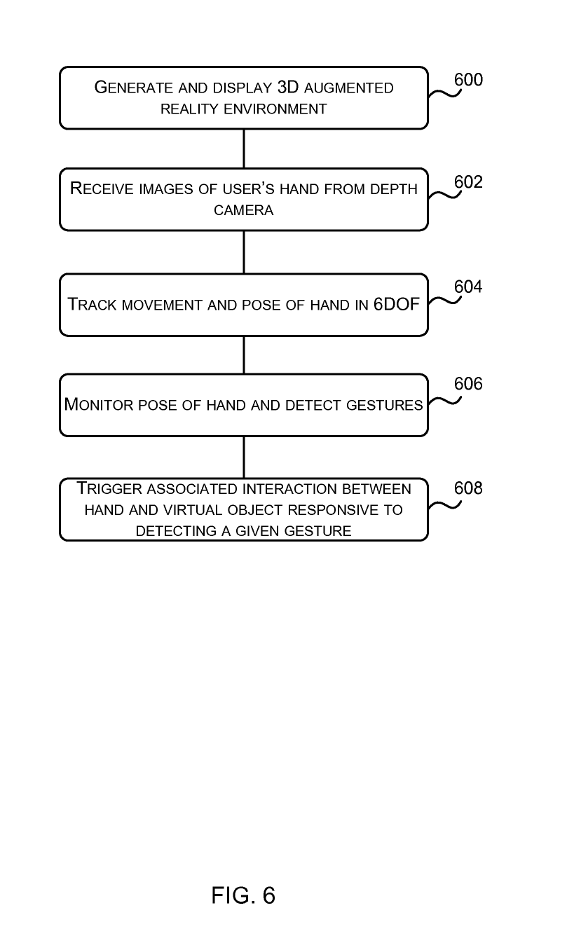

However, in the direct-interaction augmented reality system of FIG. 1, the user 100 can find it difficult to control accurately how the interaction is occurring with the virtual objects. This is because the user cannot actually feel the presence of the virtual objects, and hence it can be difficult for the user to tell precisely when they are touching a virtual object. In other words, the user has only visual guidance for the interaction, and no tactile or haptic feedback. Furthermore, it is beneficial if the user can be provided with complex, rich interactions, that enable the user to interact with the virtual objects in ways they leverage their flexible virtual nature (i.e. without being constrained by real-world limitations), whilst at the same time being intuitive. This is addressed by the flowcharts shown in FIGS. 2 and 6. FIG. 2 illustrates a flowchart of a process for providing haptic feedback in a direct interaction augmented reality system, and FIG. 6 illustrates a flowchart of a process for detecting gestures to control interaction in a direct interaction augmented reality system.

The flowchart of FIG. 2 is considered first. Firstly, the computing device 110 (or a processor within the computing device 110) generates and displays 200 the 3D augmented reality environment 102 that the user 100 is to interact with. The augmented reality environment 102 can be any type of 3D scene with which the user can interact.

Images are received 202 from the camera 106 at the computing device 110. The images show a first and second object controlled by the user 100. The first object is used as an interaction proxy and frame of reference, as described below, and the second object is used by the user to directly interact with a virtual object. For example, the first object can be a non-dominant hand of the user 100 (e.g. the user's left hand if they are right-handed, or vice versa) and the second object can be the dominant hand of the user 100 (e.g. the user's right hand if they are right-handed, or vice versa). In other examples, the first object can be an object held by the user, a forearm, a palm of either hand, and/or a fingertip of either hand, and the second object can be a digit of the user's dominant hand.

The images from the camera 106 are then analyzed by the computing device 110 to track 204 the position, movement, pose, size and/or shape of the first and second objects controlled by the user. If a depth camera is used, then the movement and position in 3D can be determined, as well as an accurate size.

Once the position and orientation of the first and second object has been determined by the computing device 110, an equivalent, corresponding position and orientation is calculated in the augmented reality environment. In other words, the computing device 110 determines where in the augmented reality environment the real objects are located given that, from the user's perspective, the real objects occupy the same space as the virtual objects in the augmented reality environment. This corresponding position and orientation in the virtual scene can be used to control direct interaction between the real objects and the virtual objects.

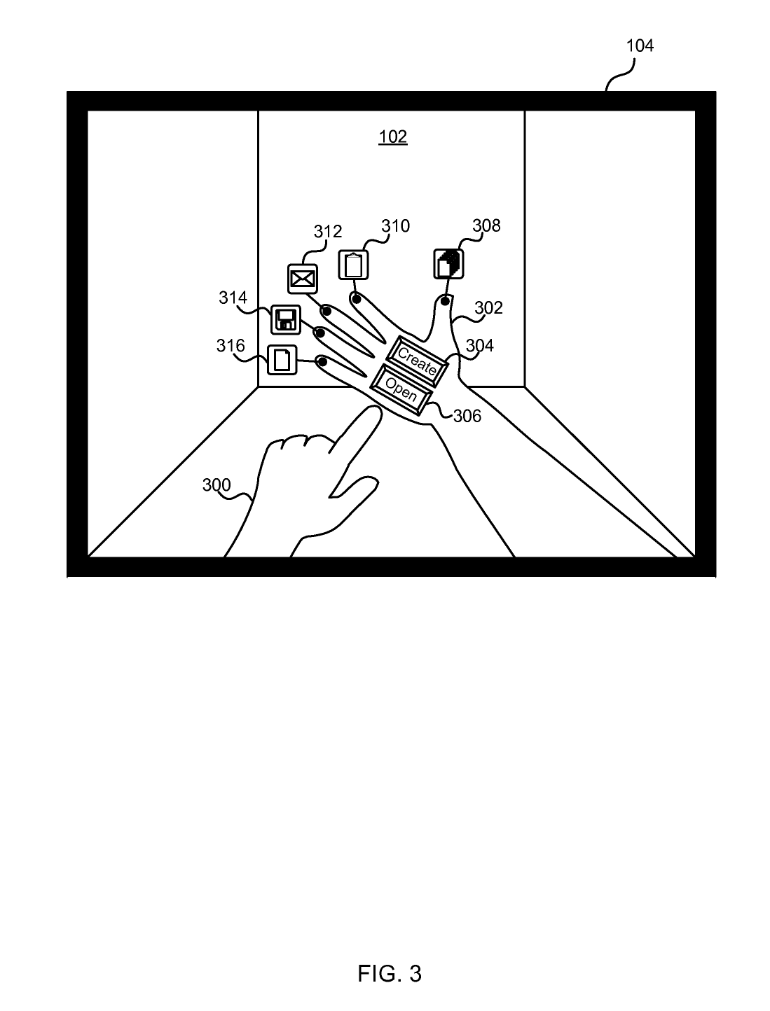

Once the corresponding position and orientation of the objects has been calculated for the augmented reality environment, the computing device 110 can use this information to update the augmented reality environment to display spatially aligned graphics (this utilizes information on the users gaze or head position, as outlined below with reference to FIG. 9). The computing device 110 can use the corresponding position and orientation to render 206 a virtual object that maintains a relative spatial relationship with the first object. For example, the virtual object can be rendered superimposed on (i.e. coincident with) or around the first object, and the virtual object moves (and optionally rotates, scales and translates) with the movement of the first object. Examples, of virtual objects rendered relative to the first object are described below with reference to FIGS. 3 to 5.

The user 100 can then interact with the virtual object rendered relative to the first object using the second object, and the computing device 110 uses the tracked locations of the objects such that interaction is triggered 208 when the first and second objects are in contact. In other words, when a virtual object is rendered onto or around the first object (e.g. the user's non-dominant hand), then the user can interact with the virtual object when the second object (e.g. the user's dominant hand) is touching the first object. To achieve this, the computing device 110 can use the information regarding the position and orientation of the first object to generate a virtual “touch plane”, which is coincident with a surface of the first object, and determine from the position of the second object that the second object and the touch plane converge. Responsive to determining that the second object and the touch plane converge, the interaction can be triggered.

In a further example, the virtual object is not rendered on top of the first object, but is instead rendered at a fixed location. In this example, to interact with the virtual object, the user moves the first object to be coincident with the virtual object, and can then interact with the virtual object using the second object.

The result of this is that the user is using the first object as a frame of reference for where in the augmented reality environment the virtual object is located. A user can intuitively reach for a part of their own body, as they have an inherence awareness of where their limbs are located in space. In addition, this also provides haptic feedback, as the user can feel the contact between the objects, and hence knows that interaction with the virtual object is occurring. Because the virtual object maintains the spatial relationship with first object, this stays true even if the user's objects are not held at a constant location, thereby reducing mental and physical fatigue on the user.

Reference is now made to FIG. 3, which illustrates an augmented reality environment that uses the haptic feedback mechanism of FIG. 2 to render user-actuatable controls on a user's hand. FIG. 2 shows the augmented reality environment 102 displayed on the display device 104. The augmented reality environment 102 comprises a dominant hand 300 of the user 100, and a non-dominant hand 302 of the user 100. The computing device 110 is tracking the movement and pose of both the dominant and non-dominant hands. The computing device 110 has rendered virtual objects in the form of a first button 304 labeled “create”, and a second button 306 labeled “open”, such that they appear to be located on the surface of the palm of the non-dominant hand 302 from the perspective of the viewing user.

The user 100 can then use a digit of the dominant hand 300 to actuate the first button 304 or second button 306 by touching the palm of the non-dominant hand 302 at the location of the first button 304 or second button 306, respectively. The user 100 can feel when they touch their own palm, and the computing device 110 uses the tracking of the objects to ensure that the actuation of the button occurs when the dominant and non-dominant hands make contact.

Note that in other examples, the virtual object can be in the form of different types of controls can be rendered, such as menu items, toggles, icons, or any other type of user-actuatable control. In further examples, the controls can be rendered elsewhere on the user's body, such as along the forearm of the non-dominant hand.

FIG. 3 illustrates further examples of how virtual objects in the form of controls can be rendered onto or in association with the user's real objects. In the example of FIG. 3, controls are associated with each fingertip of the user's non-dominant hand 302. The computing device 110 has rendered virtual objects in the form of an icon or tool-tip in association with each fingertip. For example, FIG. 3 shows a “copy” icon 308, “paste” icon 310, “send” icon 312, “save” icon 314 and “new” icon 316 associated with a respective fingertip. The user 100 can then activate a desired control by touching the fingertip associated with the rendered icon. For example, the user 100 can select a “copy” function by touching the tip of the thumb of the non-dominant hand 302 with a digit of the dominant hand 300. Again, haptic feedback is provided by feeling the contact between the dominant and non-dominant hands. Note that any other suitable functions can alternatively be associated to the fingertips, including for example a “cut” function, a “delete” function, a “move” function, a “rotate” function, and a “scale” function.

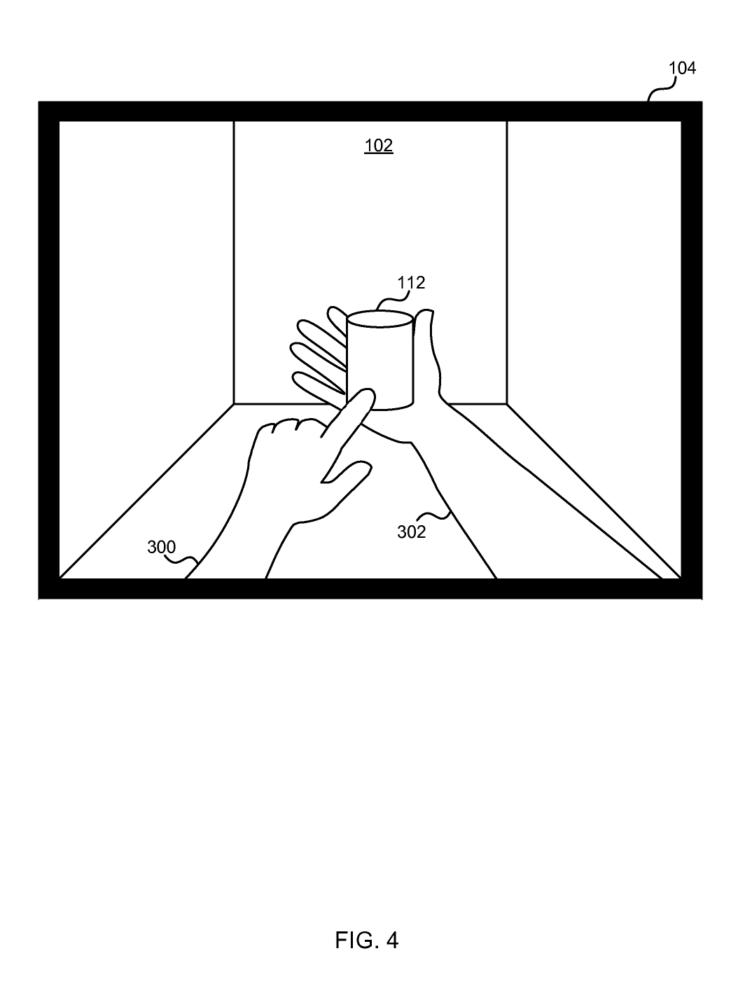

FIG. 4 illustrates another example of how the haptic feedback mechanism of FIG. 2 can be used when interacting with a virtual object. In this example, the user 100 is holding virtual object 112 in the palm of non-dominant hand 302. The can, for example, have picked up the virtual object 112 as described above. The user 100 can then manipulate the virtual object 112, for example by rotation, scaling, selection or translation, by using the dominant hand 300 to interact with the virtual object. Other example operations and/or manipulations that can be performed on the virtual object include warping, shearing, deforming (e.g. crushing or “squishing”), painting (e.g. with virtual paint), or any other operation that can be performed by the user in a direct interaction environment. The interaction is triggered when the user's dominant hand 300 is touching the palm of the non-dominant hand 302 in which the virtual object 112 is located. For example, the user 100 can rotate the virtual object 112 by tracing a circular motion with a digit of the dominant hand 300 on the palm of the non-dominant hand 302 holding the virtual object 112.

By manipulating the virtual object 112 directly in the palm of the non-dominant hand 302, the manipulations are more accurate as the user has a reference plane on which to perform movements. Without such a reference plane, the user's dominant hand makes the movements in mid-air, which is much more difficult to control precisely. Haptic feedback is also provided as the user can feel the contact between the dominant and non-dominant hands.

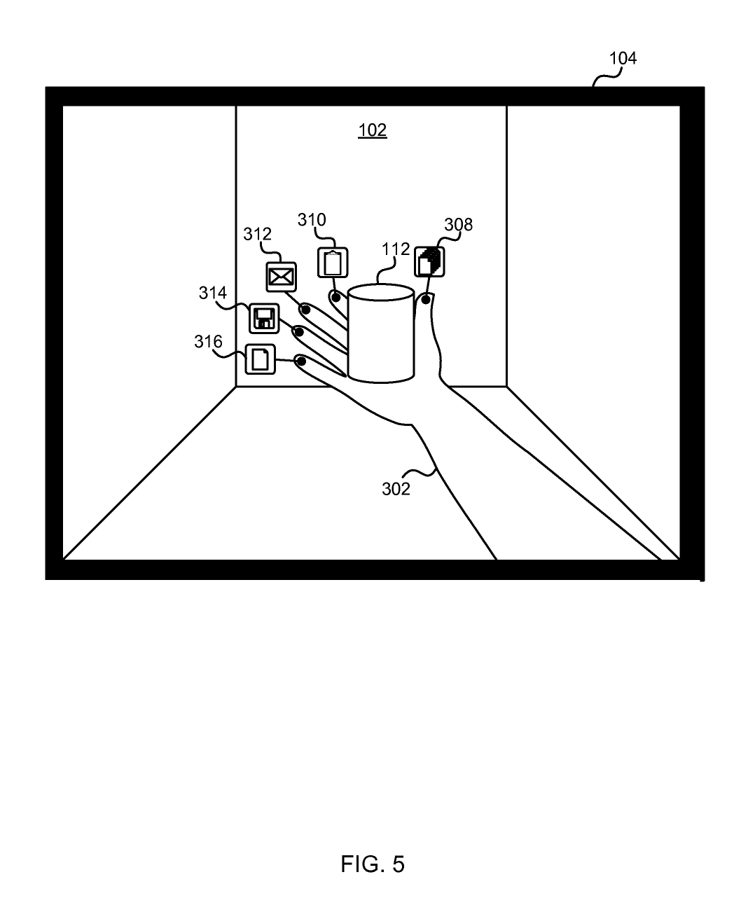

FIG. 5 illustrates a further example of the use of the haptic feedback mechanism of FIG. 2. This example illustrates the user triggering interactions using different body parts located on a single hand. As with the previous example, the user 100 is holding virtual object 112 in the palm of hand 302. The computing device 110 has also rendered icons or tool-tips in association with each of the fingertips of the hand 302, as described above with reference to FIG. 3. Each of the icons or tool-tips relate to a control that can be applied to the virtual object 112. The user can then activate a given control by bending the digit associated with the control and touching the fingertip to the palm of the hand in which the virtual object is located. For example, the user can copy the virtual object located in the palm of their hand by bending the thumb and touching the palm with the tip of the thumb. This provides a one-handing interaction technique with haptic feedback.

In another example, rather than touching the palm with a fingertip, the user 100 can touch two fingertips together to activate a control. For example, the thumb of hand 302 can act as an activation digit, and whenever the thumb is touched to one of the other fingertips, the associated control is activated. For example, the user 100 can bring the fingertips of the thumb and first finger together to paste a virtual object into the palm of hand 302.

The above-described examples all provide haptic feedback to the user by using one object as an interaction proxy for interaction between another object and a virtual object (in the form of an object to be manipulated or a control). These examples can be used in isolation or combined in any way.

Reference is now made to FIG. 6, which illustrates a flowchart of a process for detecting gestures to control interaction in a direct interaction augmented reality system, such as that described with reference to FIG. 1. The process of FIG. 6 enables a user to perform rich interactions with virtual objects using direct interaction with their hands, i.e. without using complex menus or options.

Firstly, the computing device 110 (or a processor within the computing device 110) generates and displays 600 the 3D augmented reality environment 102 that the user 100 is to interact with, in a similar manner to that described above. The augmented reality environment 102 can be any type of 3D scene with which the user can interact.

Depth images showing at least one of the user's hands are received 602 from depth camera 106 at the computing device 110. The depth images are then used by the computing device 110 to track 604 the position and pose of the hand of the user in six degrees-of-freedom (6DOF). In other words, the depth images are used to determine not only the position of the hand in three dimensions, but also its orientation in terms of pitch, yaw and roll.

The pose of the hand in 6DOF is monitored 606 to detect a predefined gesture. For example, the pose of the hand can be compared to a library of predefined poses by the computing device 110, wherein each predefined pose corresponds to a gesture. If the pose of the hand is sufficiently close to a predefined pose in the library, then the corresponding gesture is detected. Upon detecting a given gesture, an associated interaction is triggered 608 between the hand of the user and a virtual object.

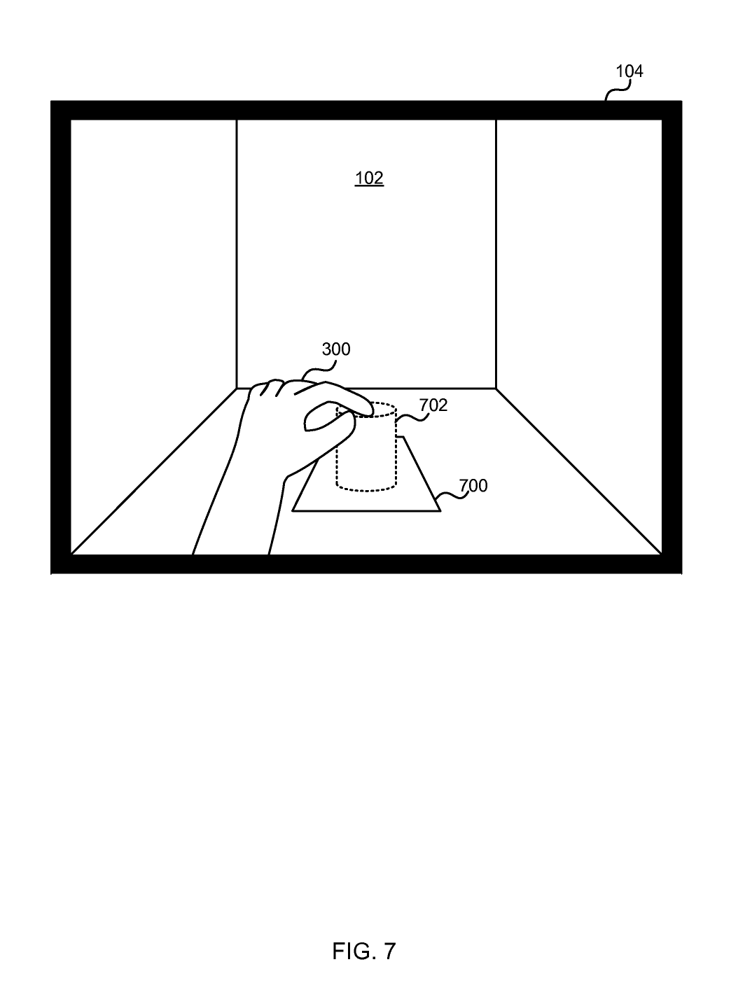

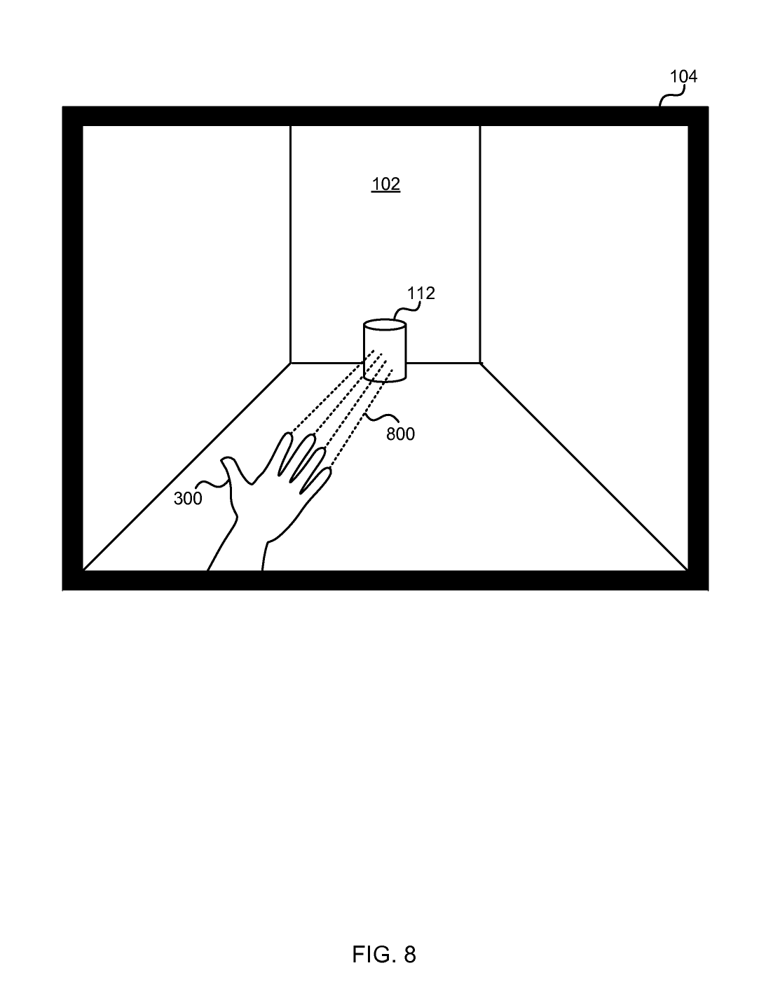

The detection of gestures enables rich, complex interactions to be used in the direct touch augmented reality environment. Examples, of such interactions are illustrated with reference to FIGS. 7 and 8 below.

FIG. 7 shows an augmented reality environment in which the user is performing a gesture for virtual object creation. The augmented reality environment 102 comprises a virtual object 700 in the form a surface on which the user 100 can use a digit of hand 300 to trace an arbitrary shape (a circle in the example of FIG. 7). The traced shape serves as “blue print” for an extrusion interaction. If the user makes a pinch gesture by bringing together the thumb and forefinger, then this gesture can be detected by the computing device 110 to trigger the extrusion. By pulling upwards the previously flat object can be extruded from the virtual object 700 and turned into a 3D virtual item 702. Releasing the pinch gesture then turns the extruded 3D virtual item 702 into an object in the augmented reality environment that can be subsequently manipulated using any of the interaction techniques described previously.

In further embodiments, a more “freeform” interaction technique can also be used, which does not utilize discrete gestures such as the pinch gesture illustrated with reference to FIG. 7. With freeform interactions, the user is able to interact in a natural way with a deformable virtual object, for example by molding, shaping and deforming the virtual object directly using their hand, in a manner akin to virtual clay. Such interactions utilize the realistic direct interaction of the augmented reality system, and do not require gesture recognition techniques.

FIG. 8 shows a further gesture-based interaction technique, which leverages the ability to perform actions in an augmented reality environment that are not readily performed in the real world. FIG. 8 illustrates an interaction technique allowing users to interact with virtual objects that are out of reach of the user.

In the example of FIG. 8, the augmented reality environment 102 comprises a virtual object 112 that is too far away for the user to be able to touch directly with their hands. The user can perform a gesture in order to trigger an interaction comprising the casting of a virtual web or net 800. For example, the gesture can be a flick of the user's wrist in combination with an extension of all five fingers. The user can steer the virtual web or net 800 whilst the hand is kept in an open pose, in order to select the desired, distant virtual object 112. An additional gesture, such as changing the hand's pose back to a closed fist, finalizes the selection and attaches the selected object to the virtual web or net 800. A further gesture of pulling the hand 300 towards the user draws the virtual object 112 into arms reach of the user 100. The virtual object 112 can then be subsequently manipulated using the any of the interaction techniques described previously.

A further example of a gesture-based interaction technique using the mechanism of FIG. 6 can operate in a similar scenario to that shown in FIG. 5. In this example, the computing device 110 can recognize the gesture of a given finger coming into contact with (e.g. tapping) the virtual object 112 located on the user's palm, and consequently trigger the function associated with the given finger. This can apply the associated function to the virtual object 112, for example executing a copy operation on the virtual object if the thumb of FIG. 5 is tapped on the virtual object 112.

Reference is now made to FIG. 9, which illustrates an example augmented reality system in which the direct interaction techniques outlined above can be utilized. FIG. 9 shows the user 100 interacting with an augmented reality system 900. The augmented reality system 900 comprises a user-interaction region 902, into which the user 100 has placed hand 108. The augmented reality system 900 further comprises an optical beam-splitter 904. The optical beam-splitter 904 reflects a portion of light incident on one side of the beam-splitter, and also transmits (i.e. passes through) a portion of light incident an opposite side of the beam-splitter. This enables the user 100, when viewing the surface of the optical beam-splitter 904, to see through the optical beam-splitter 904 and also see a reflection on the optical beam-splitter 904 at the same time (i.e. concurrently). In one example, the optical beam-splitter 904 can be in the form of a half-silvered mirror.

The optical beam-splitter 904 is positioned in the augmented reality system 900 so that, when viewed by the user 100, it reflects light from a display screen 906 and transmits light from the user-interaction region 902. The display screen 906 is arranged to display the augmented reality environment under the control of the computing device 110. Therefore, the user 100 looking at the surface of the optical beam-splitter 904 can see the reflection of the augmented reality environment displayed on the display screen 906, and also their hand 108 in the user-interaction region 802 at the same time. View-controlling materials, such as privacy film, can be used on the display screen 906 to prevent the user from seeing the original image directly on screen. Together, the display screen 906 and the optical beam-splitter form the display device 104 referred to above.

The relative arrangement of the user-interaction region 902, optical beam-splitter 904, and display screen 906 therefore enables the user 100 to concurrently view both a reflection of a computer generated image (the augmented reality environment) from the display screen 906 and the hand 108 located in the user-interaction region 902. Therefore, by controlling the graphics displayed in the reflected augmented reality environment, the user's view of their own hand in the user-interaction region 902 can be augmented.

Note that in other examples, different types of display can be used. For example, a transparent OLED panel can be used, which can display the augmented reality environment, but is also transparent. Such an OLED panel enables the augmented reality system to be implemented without the use of an optical beam splitter.

The augmented reality system 900 also comprises the camera 106, which captures images in the user interaction region 902, to allow the tracking of the real objects, as described above. In order to further improve the spatial registration of the augmented reality environment with the user's hand 108, a further camera 908 can be used to track the face, head or eye position of the user 100. Using head or face tracking enables perspective correction to be performed, so that the graphics are accurately aligned with the real objects. The camera 908 shown in FIG. 9 is positioned between the display screen 906 and the optical beam-splitter 904. However, in other examples, the camera 908 can be positioned anywhere where the user's face can be viewed, including within the user-interaction region 902 so that the camera 908 views the user through the optical beam-splitter 904. Not shown in FIG. 9 is the computing device 110 that performs the processing to generate the augmented reality environment and controls the interaction, as described above.

This augmented reality system can utilize the interaction techniques described above to provide improved direct interaction between the user 100 and the virtual objects rendered in the augmented reality environment. The user's own hands (or other body parts or held objects) are visible through the optical beam splitter 904, and by visually aligning the augmented reality environment 102 and the user's hand 108 (using camera 908) it can appear to the user 100 that their real hands are directly manipulating the virtual objects. Virtual objects and controls can be rendered so that they appear superimposed on the user's hands and move with the hands, enabling the haptic feedback technique, and the camera 106 enables the pose of the hands to be tracked and gestures recognized.

Reference is now made to FIG. 10, which illustrates various components of computing device 110. Computing device 110 may be implemented as any form of a computing and/or electronic device in which the processing for the augmented reality direct interaction techniques may be implemented.

Computing device 110 comprises one or more processors 1002 which may be microprocessors, controllers or any other suitable type of processor for processing computer executable instructions to control the operation of the device in order to implement the augmented reality direct interaction techniques.

The computing device 110 also comprises an input interface 1004 arranged to receive and process input from one or more devices, such as the camera 106. The computing device 110 further comprises an output interface 1006 arranged to output the augmented reality environment 102 to display device 104.

The computing device 110 also comprises a communication interface 1008, which can be arranged to communicate with one or more communication networks. For example, the communication interface 1008 can connect the computing device 110 to a network (e.g. the internet). The communication interface 1008 can enable the computing device 110 to communicate with other network elements to store and retrieve data.

Computer-executable instructions and data storage can be provided using any computer-readable media that is accessible by computing device 110. Computer-readable media may include, for example, computer storage media such as memory 1010 and communications media. Computer storage media, such as memory 1010, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device. In contrast, communication media may embody computer readable instructions, data structures, program modules, or other data in a modulated data signal, such as a carrier wave, or other transport mechanism. Although the computer storage media (such as memory 1010) is shown within the computing device 110 it will be appreciated that the storage may be distributed or located remotely and accessed via a network or other communication link (e.g. using communication interface 1008).

Platform software comprising an operating system 1012 or any other suitable platform software may be provided at the memory 1010 of the computing device 110 to enable application software 1014 to be executed on the device. The memory 1010 can store executable instructions to implement the functionality of a 3D augmented reality environment rendering engine 1016, object tracking engine 1018, haptic feedback engine 1020 (arranged to triggering interaction when body parts are in contact), gesture recognition engine 1022 (arranged to use the depth images to recognize gestures), as described above, when executed on the processor 1002. The memory 1010 can also provide a data store 1024, which can be used to provide storage for data used by the processor 1002 when controlling the interaction in the 3D augmented reality environment.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of direct user-interaction in an augmented reality system, comprising:
controlling, using a processor, a display device to display a three-dimensional augmented reality environment comprising a virtual object and a real first and second object controlled by a user;
receiving, at the processor, a sequence of images from at least one camera showing the first and second object, and using the images to track the position of the first and second object in three dimensions;
enabling interaction between the second object and the virtual object when the first and second object are in contact at the location of the virtual object from the perspective of the user.

2. A method according to claim 1, wherein the first object comprises at least one of: an object held in a hand of the user; a hand; a forearm; a palm of a hand; and a fingertip of a hand.

3. A method according to claim 1, wherein the second object comprises a digit of a hand.

4. A method according to claim 1, wherein the virtual object is a user-actuatable control.

5. A method according to claim 4, wherein the user-actuatable control comprises at least one of: a button; a menu item; a toggle; and an icon.

6. A method according to claim 4, wherein the step of enabling interaction comprises the second object actuating the control.

7. A method according to claim 1, wherein the step of enabling interaction comprises the second object performing at least one of: a rotation operation; a scaling operation; a translation operation; a warping operation; a shearing operation; a deforming operation; a painting operation; and a selection operation on the virtual object.

8. A method according to claim 1, wherein step of enabling interaction comprises generating a touch plane coincident with a surface of the first object, determining from the position of the second object that the second object and the touch plane converge, and, responsive thereto, triggering the interaction between the second object and the virtual object.

9. A method according to claim 1, wherein the step of using the position and orientation of the first object to update the augmented reality environment to display the virtual object comprises rendering the virtual object on a surface of the first object from the perspective of the user.

10. A method according to claim 1, further comprising the step of updating the location of the virtual object in the augmented reality environment to move the virtual object in accordance with a corresponding movement of the first object to maintain a relative spatial arrangement from the perspective of the user.

11. A method according to claim 1, wherein the camera is a depth camera arranged to capture images having a plurality of image elements, each image element having a value indicating a distance between the camera and a corresponding portion of the first or second object.

12. An augmented reality system, comprising:
a display device arranged to display a three-dimensional augmented reality environment comprising a virtual object and a real hand of a user;
a depth camera arranged to capture images of the hand of the user having a plurality of image elements, each image element having a value indicating a distance between the camera and a corresponding portion of the hand;
a processor arranged to receive the depth camera images, track the movement and pose of the hand of the user in six degrees of freedom, monitor the pose of the hand to detect a predefined gesture, and, responsive to detecting the predefined gesture, trigger an associated interaction between the hand of the user and the virtual object.

13. An augmented reality system according to claim 12, wherein the predefined gesture comprises movement of a digit of the hand associated with a function into contact with the virtual object, and the associated interaction comprises applying the function to the virtual object.

14. An augmented reality system according to claim 13, wherein the function comprises at least one of: a copy function; a paste function; a cut function; a delete function; a move function; a warping operation; a shearing operation; a deforming operation; a painting operation; a rotate function; and a scale function.

15. An augmented reality system according to claim 12, wherein the predefined gesture comprises a pinch gesture, and the associated interaction comprises extrusion of a 3D virtual item from the virtual object based on a two-dimensional cross-section traced by the user's hand.

16. An augmented reality system according to claim 15, wherein the processor is further arranged to enable the user to manipulate the 3D virtual item in the augmented reality environment, responsive to release of the pinch gesture.

17. An augmented reality system according to claim 12, wherein the predefined gesture comprises an extension of a plurality of digits of the hand towards the virtual object, and the associated interaction comprises the drawing of the virtual object towards the user, despite the virtual object being out of reach of the user's hand.

18. An augmented reality system according to claim 12, wherein the display device comprises: a display screen arranged to display the virtual object; and an optical beam-splitter positioned to reflect light from the display screen on a first side of the beam-splitter, and transmit light from an opposite side of the beam-splitter, such that when the hand of the user is located on the opposite side, both the virtual object and the hand are concurrently visible to the user on the first side of the beam-splitter.

19. An augmented reality system according to claim 12, wherein the display device comprises: a video camera mountable on the user's head and arranged to capture images in the direction of the user's gaze; and a display screen mountable on the user's head and arranged to display the video camera images combined with the virtual object.

20. One or more tangible device-readable media with device-executable instructions that, when executed by a computing device, direct the computing device to perform steps comprising:
generating a three-dimensional augmented reality environment comprising a virtual object and a real first hand and second hand of one or more users;
controlling a display device to display the virtual object and the first hand and second hand;
receiving a sequence of images from a depth camera showing the first hand and second hand;
analyzing the sequence of images to determine a position and pose of each of the first hand and second hand in six degrees of freedom;
using the position and pose of the second hand to render the virtual object at a location in the augmented reality environment such that the virtual object appears to be located on the surface of the second hand from the perspective of the user, and moving the virtual object in correspondence with movement of the second hand; and
triggering interaction between the first hand and the virtual object at the instance when the position and pose of the first hand and second hand indicates that a digit of the first hand is touching the second hand at the location of the virtual object.
